(19) United States
(12) Patent Application Publication
(10) Pub. No.: US 2001/0022127 A1
(43) Pub. Date: Sep. 20, 2001

(54) MUSICMASTER-ELECTRONIC MUSIC BOOK

(76) Inventors: VINCENT CHIURAZZI, SAN MATEO, CA (US); JOHN EUGENE CONTE JR., CORTE MADERA, CA (US)

Correspondence Address: JACK LO, 617 VIEWRIDGE DRIVE, PACIFICA, CA, 94044

(21) Appl. No.: 08/955,851

(22) Filed: Oct. 21, 1997

(51) Int. Cl. G10F 1/02

(52) U.S. Cl. 84/47

(57) ABSTRACT

A TWO SCREEN ELECTRONIC MUSIC BOOK WHICH RETREIVES AND DISPLAYS MUSIC SCORES THAT ARE ENCODED ON DISKS OR ROMS OR COMPUTER-CARDS, OR ANY CONTEMPORARY MEANS, IN THE FASHION OF STANDARD PRINT MUSIC. EACH OF THE TWO SCREENS ARE THE SIZE OF STANDARD SHEET MUSIC, APPROXIMATELY NINE INCHES WIDE BY TWELVE INCHES HIGH, AND THE NOTATION SIZE OF THE MUSIC ITSELF IS THE SIZE OF MUSIC FOUND IN STANDARD SHEET MUSIC AND STANDARD MUSIC BOOKS. A COMPUTER TYPE KEYBOARD ALLOWS THE USER TO IMPUT DATA IN ORDER TO RETREIVE ANY OF THE THOUSANDS OF MUSIC TITLES WHICH ARE AVAILABLE. THE USER MAY SELECT THROUGH VARIOUS MEANS, SUCH AS BY COMPOSER, SONG TITLE, AND SPECIFIC MUSIC BOOK SELECTION. MUSIC COMPILED INCLUDES; SINGLE SONG, VARIOUS COMPILATIONS, ANTHOLOGIES, COMPOSER CLASSICS, JAZZ AND POPULAR, EDUCATIONAL MATERIAL, AND OTHERS. A SEEK AND SCAN FUNCTION PERMITS BROWSING THROUGH SELECTIONS. A PROGRAMMABLE PRE-SET SELECT FUNCTION PERMITS PERSONNAL SONG SELECTION ORDER. REPEAT, PAGE TURN FORWARD, PAGE TURN BACK, DA CAPO, DAL SEGNO, AND CODA ARE KEY-TYPE FUNCTION COMMANDS WHICH RETURN THE USER TO THE CORRECT PAGES ON THE DISPLAY SCREENS IN ORDER THAT THE MUSIC CAN BE PERFORMED AS INDICATED BY THE MUSIC. OTHER FEATURES INCLUDE MIDI IN AND MIDI OUT FOR INTERFACE, OPERATION BY INTERNAL POWER CELL OR A/C POWER, A PRINTER FUNCTION WHICH ALLOWS ANY OF SAID ELECTRONIC MUSIC BOOK'S CONTENTS TO BE PRINTED. ADDITIONAL FEATURES MAY BE INCLUDED IN THE MUSIC BOOK SUCH AS, TRANSPOSE AND AUDIO OUT, ALLOWING ANY OF ELECTRONIC MUSIC BOOK'S CONTENTS TO BE HEARD. THE BOOK OPENS IN A HINGE TYPE MANNER AND CAN BE PLACED ONTO A PIANO, A MUSIC STAND, OR LAID FLAT ON A FLAT SURFACE. IT IS DURABLE, CLOSES SECURELY, AND IS MEANT TO FUNCTION AS STANDARD PRINT MUSIC DOES. A PORTABLE, CUSTOM SELECTED MASSIVE REPERTOIRE OF MUSIC DESIGNED TO BE USER-FRIENDLY AND PERFORMANCE ORIENTED.

### BACKGROUND OF THE INVENTION

THE NEED FOR MUSICMASTER EXISTS BECAUSE OF TWO FUNDAMENTAL LIMITATIONS INHERENT IN TRADITIONAL PRINT MUSIC. AS TIME PASSES MUSIC OF A LASTING QUALITY INCREASES THEREBY THE QUANITY OF MUSIC WE NEED TO POSSESS IS ALWAYS INCREASING. A LARGE QUANTITY OF MUSIC IS VERY HEAVY AND OCCUPIES LOTS OF SPACE. MUSICMASTER IS ONE BOOK BUT BECAUSE OF ITS ELECTRONIC AND COMPUTER ABILITIES THOUSANDS OF MUSIC TITLES, VARIOUS COMPILATIONS, ENTIRE WORKS OF MUSIC, INSTRUCTION BOOKS, AND ANY OF A VARIETY OF ANTHOLOGIES CAN NOW BE MADE PORTABLE. IN ADDITION TO SPACE CONSERVATION AND A DRASTIC REDUCTION IN WEIGHT, MUSICMASTER NOW MAKES THIS HUGE BODY OF MUSIC USABLE.

ALTHOUGH MUSICMASTER EMBODIES AND MAKES PORTABLE A HUGH VOLUME OF MUSIC INTO A SINGLE BOOK, IT ALSO ADDRESSES THE NEED FOR AN ELECTRONIC MUSIC BOOK TO BE PERFORMANCE ORIENTED. MUSICMASTER SATISFIES THIS NEED BECAUSE IT HAS TWO SCREENS ON WHICH MUSIC IS DISPLAYED, EXACTLY THE SIZE OF TRADITIONAL PRINT MUSIC. THE PERFORMING MUSICIAN OR STUDENT, OR AMATEUR, CAN NOW USE MUSICMASTER AS THEY WOULD ANY PIECE OF TRADITIONAL PRINT FORMAT MUSIC, IN THAT THE MUSIC IS STANDARD PRINT SIZE AND READS FROM ONE PAGE (SCREEN), TO THE NEXT PAGE (SCREEN). IN ORDER FOR AN ELECTRONIC MUSIC BOOK TO BE MORE THAN JUST HIGH CAPACITY STORAGE IT IS NECESSARY THAT THE MUSIC BOOK DISPLAY IT'S CONTENTS IN A WAY WHICH MAKES THE MUSIC PERFORMABLE. SINGLE SCREENS, SCROLLING, A REDUCTION OF NOTE SIZE, A REDUCTION OF PAGE SIZE, ALL MAKE PRIOR ELECTRONIC MUSIC BOOK IDEAS FAIRLY USELESS. WHAT MAKES MUSICMASTER VERY DIFFERENT IS THAT IT CAN BE USED EXACTLY AS SHEET MUSIC AND MUSIC BOOKS ARE USED. THE NOTATION SIZE IS THE SIZE OF STANDARD PRINT MUSIC AND THE SIZE OF ITS DUAL SCREENS ARE THE SIZE OF STANDARD MUSIC BOOKS AND SHEET MUSIC. READING MUSIC FROM MUSICMASTER IS AS CONGENIAL AS READING MUSIC FROM ORDINARY PRINT MUSIC. HAVING THESE QUALITIES, MUSICMASTER NOW MAKES THE IDEA OF AN ELECTRONIC MUSIC BOOK ONE THAT IS USEFUL. MUSICMASTER AFFORDS THE INDIVIDUAL AN INCREDIBLE CONVENIENCE, A HERETOFORE UNIMAGINABLE SINGLE, PORTABLE, USABLE MASSIVE LIBRARY OF REPERTOIRE.

### DISCUSSION OF PRIOR ART—BACKGROUND

ORIGINALLY ELECTRONIC MUSIC BOOKS WERE CONCEIVED USING ONLY ONE DISPLAY SCREEN. TYPICALLY THE SIZE OF THE SCREEN AND THE SIZE OF THE DISPLAYED NOTATION IS SMALLER THAN THE SIZE OF STANDARD MUSIC PRINT. IN ADDITION, WE HAVE NOT SEEN IN ANY PRIOR ART THE MENTION OF ESSENTIAL KEY COMMAND FUNCTIONS SUCH AS “REPEAT”, “DAL SEGNO”, “DA CAPO”, AND “CODA”. THESE FUNCTIONS ARE PART OF OUR ELECTRONIC MUSIC BOOKS HARDWARE, CONNECTED IN SUCH A WAY TO THE DATA THAT IT TAKES YOU BACK TO SPECIFIC PARTS WITHIN THE MUSIC, SUCH AS “REPEAT”, OR “DA CAPO”, OR “CODA”. THESE FUNCTIONS ARE ACCESSED BY KEY COMMAND BUTTONS LOCATED ON OUR ELECTRONIC MUSIC BOOK AND ARE ABSOLUTELY NECESSARY WHEN USING, “READING” MUSIC FROM AN ELECTRONIC MUSIC BOOK. SUCH KEY COMMANDS NAVIGATE THE USER THROUGH THE PARTICULAR PIECE OF MUSIC WHICH HE/SHE HAS RETREIVED FROM SAID ELECTRONIC MUSIC BOOK'S CONTENTS.

REFERRING NOW TO U.S. PAT. NO. DES. 346,620, ON MAY 3, 1994, JEFFERY E. McSORELY, THE INVENTOR DESCRIBES AN ELECTRONIC MUSIC BOOK, THIS BOOK HOWEVER ONLY HAS ONE SCREEN AND IS NOT VERY USABLE IN PRACTICAL ORDINARY PERFORMANCE SITUATIONS. IT ALSO LACKS THE ESSENTIAL KEY COMMANDS DISCUSSED ABOVE, NECESSARY WHEN PERFORMING MUSIC USING THE ELECTRONIC MUSIC BOOK.

REFERRING NOW TO U.S. PAT. NO. 4,350,070. ON SEP. 21, 1982, SOHAIL E. BAHU, THE INVENTOR, DESCRIBES AN ELECTRONIC MUSIC BOOK, THIS BOOK HOWEVER ONLY HAS ONE SCREEN AND IS NOT VERY USABLE IN ORDINARY PERFORMANCE SITUATIONS. THERE IS ALSO NO MENTION OF ESSENTIAL KEY COMMANDS SUCH AS “DAL SEGNO”, “DA CAPO”, OR “CODA”. WITHOUT THESE TWO ESSENTIAL ASPECTS THIS ELECTRONIC MUSIC BOOK IS NOT VERY USABLE IN ORDINARY PERFORMANCE SITUATIONS.

REFERRING NOW TO U.S. PAT. NO. 5,339,091. ON AUG. 16, 1994, THE INVENTORS SHUMPEI YAMAZAKI AND TOSHIJI HAMATANI DESCRIBE A SOMEWHAT RELATED INVENTION, A PAPERLESS PORTABLE BOOK. THIS BOOK HOWEVER ONLY HAS ONE SCREEN.

REFERRING NOW TO U.S. PAT. NO. 4,985,697. ON JAN. 15, 1991, THE INVENTOR DAVID A. BOULTON DESCRIBES AN ELECTRONIC BOOK, A METHOD FOR COMPILING AND PRESENTING EDUCATIONAL MATERIAL. AGAIN, ALTHOUGH A RELATED PRODUCT, ONE THAT USES ONLY ONE SCREEN.

REFERRING NOW TO U.S. PAT. NO. 5,392,387. ON FEB. 21, 1995, THE INVENTORS GREGORY P. FITZPATRICK AND THOMAS R. HAYNES DESCRIBE AN ELECTRONIC BOOK FOR ENHANCED DATA ACCESS EFFICIENCY. NOTHING TO DO WITH MUSIC, BUT A SOMEWHAT RELATED PRODUCT. AGAIN, ONLY ONE SCREEN.

REFERRING NOW TO U.S. PAT. NO. 5,534,888. ON JUL. 9, 1996, THE INVENTORS MICHAEL S. LEBBY AND THOMAS H. BLAIR DESCRIBE SOME SORT OF ELECTRONIC BOOK WHERBY DATA CAN BE STORED. THERE IS MENTION OF A “PLURALITY OF OPTICAL DISPLAYS” AND A

### DISCUSSION OF PRIOR ART—BACKGROUNG

“PLURALITY OF PAGE DISPLAYS”. HOWEVER THERE IS NO MENTION OF TWO DISTINCT DISPLAY SCREENS THE SIZE OF STANDARD SHEET MUSIC AND MUSIC BOOKS.

OF OUR INVESTIGATION AND KNOWLEDGE OF PRIOR ART THAT EXISTS IN THE WORLD TODAY THERE ARE NO ELECTRONIC MUSIC BOOKS WHICH HAVE TWO DISTINCT DISPLAY SCREENS THE SIZE OF STANDARD PRINT MUSIC. THERE ARE NO ELECTRONIC MUSIC BOOKS WHICH DISPLAY THEIR CONTENTS ONTO THESE SCREENS IN THE ACTUAL SIZE OF STANDARD PRINT MUSIC.

### OBJECTS AND ADVANTAGES

ACCORDINGLY, SEVERAL OBJECTS AND ADVANTAGES OF OUR INVENTION ARE:

OUR ELECTRONIC MUSIC BOOK HAS TWO IDENTICAL DISPLAY SCREENS, APPROXIMATELY NINE INCHES WIDE BY TWELVE INCHES HIGH. THIS ALLOWS FOR OUR ELECTRONIC MUSIC BOOK TO DISPLAY MUSIC EXACTLY THE WAY IT APPEARS IN TRADITIONAL STANDARD PRINT FORMAT. WHEN YOU OPEN UP A MUSIC BOOK YOU SEE TWO PAGES OF MUSIC. WHEN YOU USE OUR ELECTRONIC MUSIC BOOK YOU SEE TWO SCREENS OF MUSIC. ANOTHER ADVANTAGE OF OUR INVENTION IS THAT THE NOTATION SIZE OF THE DISPLAYED MUSIC IS THE SAME SIZE OF STANDARD PRINT MUSIC.

ANOTHER OBJECT AND ADVANTAGE OF OUR INVENTION IS THAT OUR ELECTRONIC MUSIC BOOK PROVIDES THE ESSENTIAL HARDWARE KEY COMMANDS THAT ALLOW THE USER TO NAVIGATE THROUGH THE MUSIC BY PRESSING THE APPROPIATE BUTTONS WHEN SUCH DIRECTIONS IN THE MUSIC MAKE RETURNING TO A PARTICULAR PLACE IN THE MUSIC NECESSARY. FOR EXAMPLE, A USER MAY SELECT A PIECE OF MUSIC THAT IS FIVE PAGES LONG. THERE ARE DIRECTIONS WITHIN MUSIC THAT ARE INSTRUCTIONS TO RETURN OR ADVANCE TO SPECIFIC PLACES IN THE MUSIC. THEY ARE, “REPEAT”, “DA CAPO”, “DAL SEGNO”, AND “CODA”. OUR ELECTRONIC MUSIC BOOK RETURNS OR ADVANCES THE USER TO THE CORRECT PAGES THEY NEED TO RETURN TO OR ADVANCE TO IN ORDER TO CORRECTLY PERFORM THE MUSIC THEY HAVE SELECTED. THIS IS DONE ELECTRONICALLY WHEN THE USER EMPLOYS ONE OF THE KEY COMMANDS, SUCH AS “DA CAPO”.

AS THE INVENTORS OF OUR ELECTRONIC MUSIC BOOK WE FEEL THAT THE OBJECTS AND ADVANTAGES OF OUR INVENTION MAKE OUR ELECTRONIC MUSIC BOOK ONE THAT INCORPORATES ESSENTIAL ASPECTS AND FUNCTIONS OF MUSIC THAT ARE ESSENTIAL IN ORDER THAT THE INVENTION HAVE PRACTICAL APPLICATION.

FURTHER OBJECTS AND ADVANTAGES OF OUR INVENTION WILL BECOME APPARENT FROM A CONSIDERATION OF THE DRAWINGS AND ENSUING DESCRIPTION.

### LIST OF REFERENCE NUMERALS

1 Dual screen electronic music book, open.

2 ON/OFF key.

3 DISPLAY SCREEN—Left side.

4 DISPLAY SCREEN—Right side.

5 Computer Keyboard.

6 TITLE key.

7 MM key. MusicMaster key.

8 BOOK key.

9 PAGE key.

COMPOSER key.

10 PROGRAMMABLE PRE-SET keys.

11 SCAN key control.

12 SEEK key control.

13 PAGE TURN BACK command key control.

14 PAGE TURN FORWARD command key control.

15 REPEAT SIGN command key control.

16 DAL SEGNO command key control.

17 CODA command key control.

18 DA CAPO command key control.

19 BATTERY LEVEL INDICATOR.

20 PRINT command key control.

21 BRIGHTNESS control.

22 SHARPNESS control.

23 CONTRAST control.

24 MIDI IN PORT.

24a MIDI OUT PORT.

25 FLOPPY DISK AND/OR RAM

26 PRINTER PORT.

27 A/C POWER CORD.

28 CLOSURE MECHANISM.

29 HINGE

30 CLOSED BOOK FRONT.

### BRIEF DESCRIPTION OF THE DRAWINGS

FIG. 1 is a perspective view of an open dual screen electronic music book.

FIG. 2 is a blow up or exploded view of a keyboard and other key commands located at the lower left side of our invention.

FIG. 3 is a blow up view of key commands located at the lower right side of our invention.

FIG. 4 is a perspective view of our electronic music book when closed and of its front side.

FIG. 5 is a perspective view of our electronic music book when closed and of its back side.

FIG. 6 is a perspective view of our electronic music book closed showing its face side.

### DESCRIPTION OF THE INVENTION

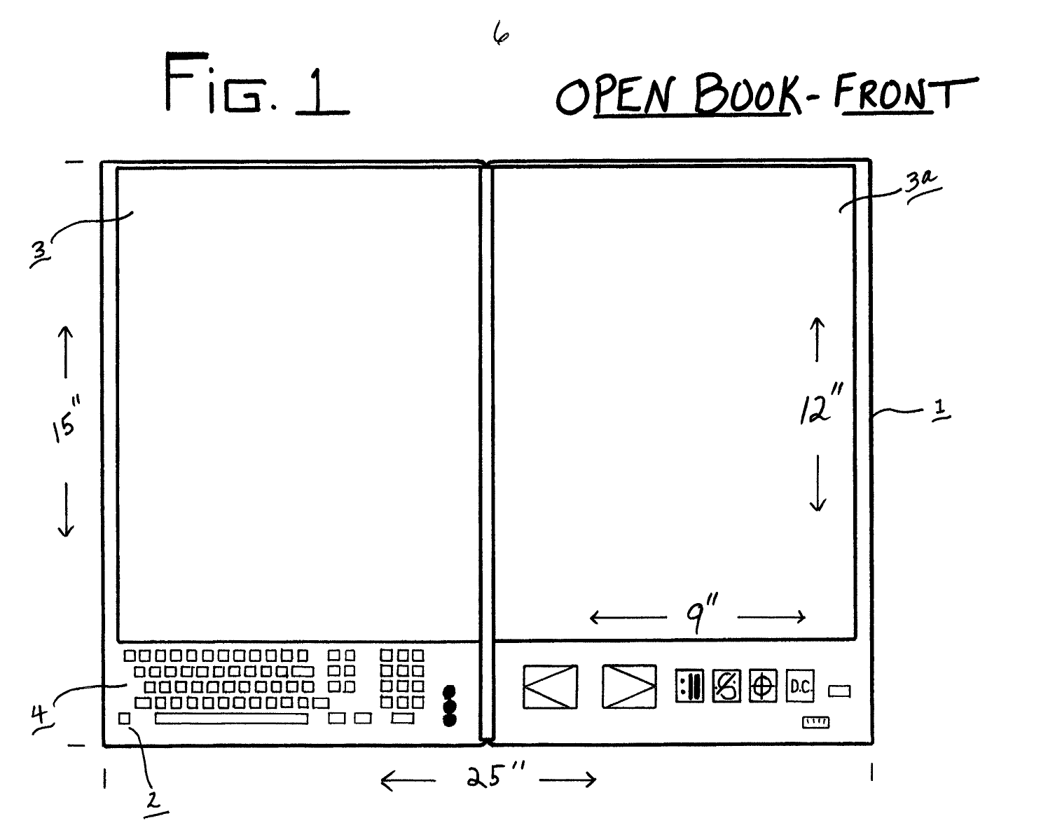

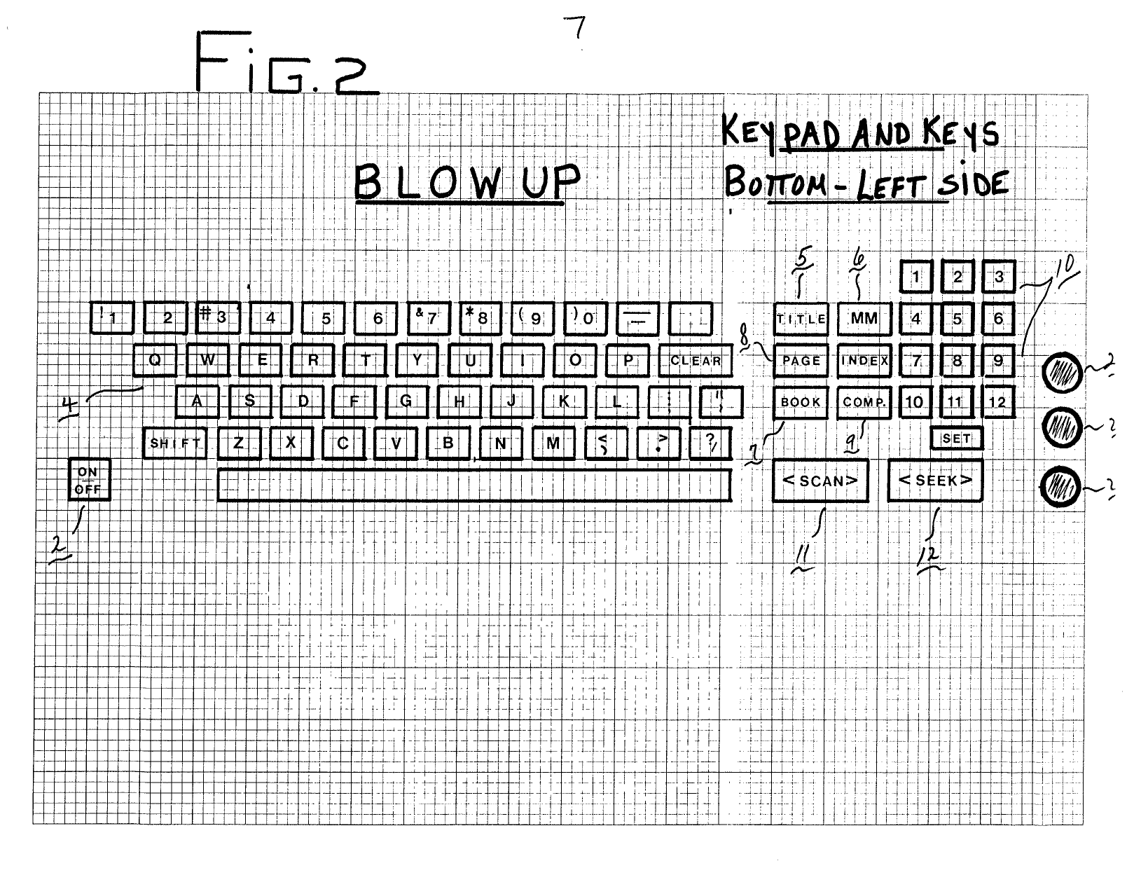

Referring now more specifically to the drawings, and to FIG. 1, numeral 1 designates an electronic music book with two display screens 3 and 3a in an open book position. In the lower left hand corner of the electronic music book is the on/off key, 2. After the book is turned on the user proceeds retrieving music from MusicMaster in several ways. Referring now to FIG. 2, a blow up view of a computer keyboard, and other music select command keys, the user selects the MM key, numeral 6, and a listing of all of MusicMaster's contents appear on screen. Music is stored as compilations volumes, typical music “fake books”, and otherwise categorized. The user may now proceed by choosing from MusicMaster's contents. Each volume, book, and category is numbered. A user would enter the number corresponding to his/her choice using the numbers section of the computer keyboard and key command 7, book enter. Now the contents of a chosen book, volume, compilation, or category appear on screen. The user now chooses the piece of music they want displayed. All titles are numbered, and one enters their choice with the numbers section of the computer keyboard and key command 8, page. The music now appears on the display screens. The size and print format of the displayed music is the same size, 9″×12″, as standard sheet and music book notation.

Other ways of retrieving music from this electronic music book are as follows: The user may know the title of the music they wish to recall. In such case one would enter the title using the computer keyboard, and key command 5, title. Another possibility is to enter the name of the composer whose music you wish to see. This is done by typing the composers name using the computer keyboard and the key command composer, numeral 9. After a listing is displayed on screen the user then proceeds in choosing their selection by entering a book, a title, or a page number using the computer keyboard and the key commands, respectively, numerals 7, 5, or 8.

In addition a user can “scan” and or “seek”, forward and backward through music books, compilations, and collections. This allows the user to “skim” through the contents of chosen music books, compilations, and collections.

Numeral 10 is a programmable pre-set feature which allows a user to store any of up to twelve music selections which then become instantly retrievable when these pre-set keys are employed. A user may change the programmed pre-sets as often as desired.

To accommodate various lighting environments MusicMaster is equipped with screen adjust control, numeral 21, brightness, numeral 22, sharpness, and numeral 23, contrast.

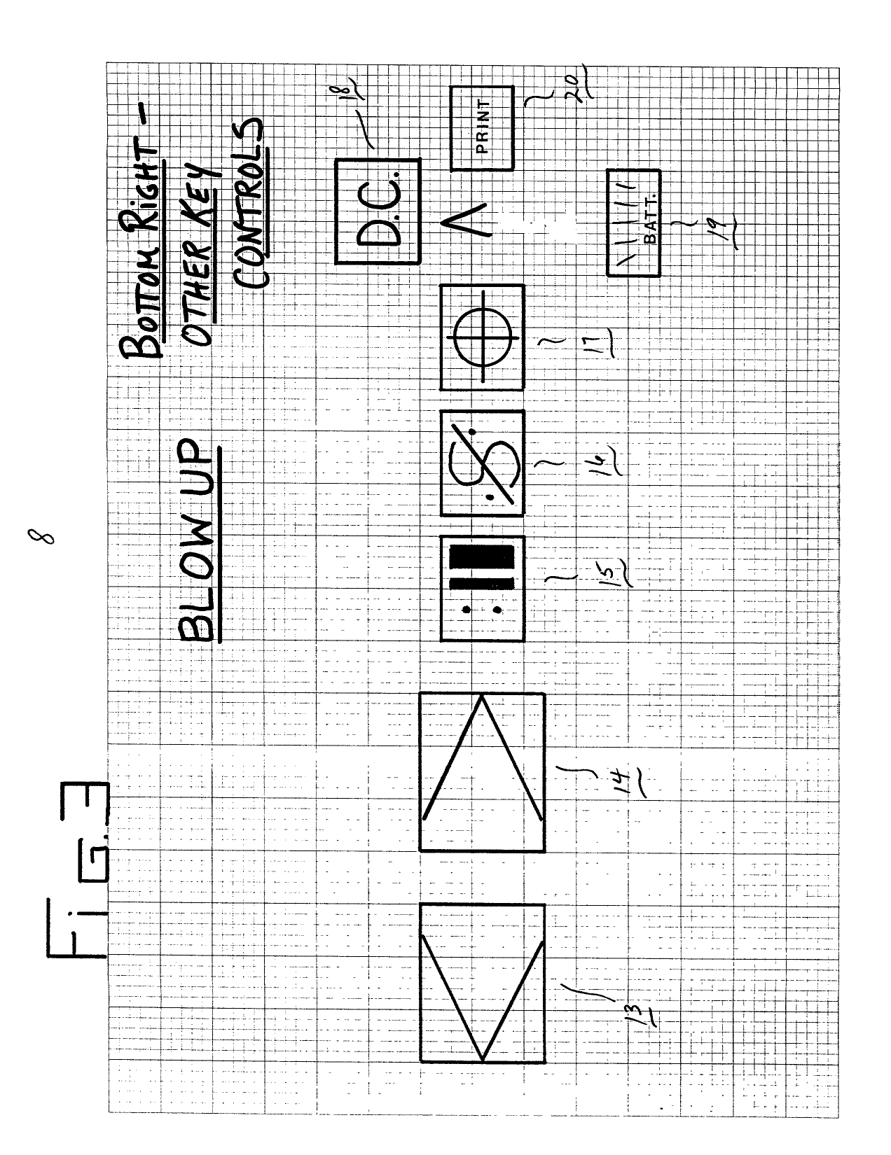

Referring now to. FIG. 3, a blow up view of the key commands found at the lower right portion or our electronic music book, beneath the right display screen, in particular numerals 13 and 14. After music is retrieved from within MusicMaster and displayed onto its screens additional music of a composition is accommodated for by the use of the turn page feature of MusicMaster. Page turns are made by using the back page turn key command, numeral 13, and the forward page turn key command, numeral 14. When music of multiple pages (more than two) is being used and a repeat sign is encountered within the music a user simply selects the repeat key, numeral 15, and the proper page of music containing the section of music which is to be repeated, will appear on screen. Likewise, when a Dal Segno instruction appears in the music the user selects the Dal Segno key command, numeral 16, and MusicMaster electronically returns to the proper page of music on which the Dat Segno appears. Numeral 17 is the key command for the instruction in music for the performer to proceed to the Coda. Again, MusicMaster electronically returns the user to the page of music which contains the Coda, when the Coda key is selected, numeral 17. Numeral 18 is the key for the Da Capo return command. Da Capo is an instruction to return to the beginning of the music and selecting key command numeral 18 returns the music to the beginning.

Numeral 19 is a battery level indicator. MusicMaster can operate on a self contained battery, and this feature allows the user to be aware of the amount of energy reserve of MusicMaster.

With the possibility of a printer accessory any of MusicMaster's contents can be printed. Numeral 20 is the print command key of our electronic music book.

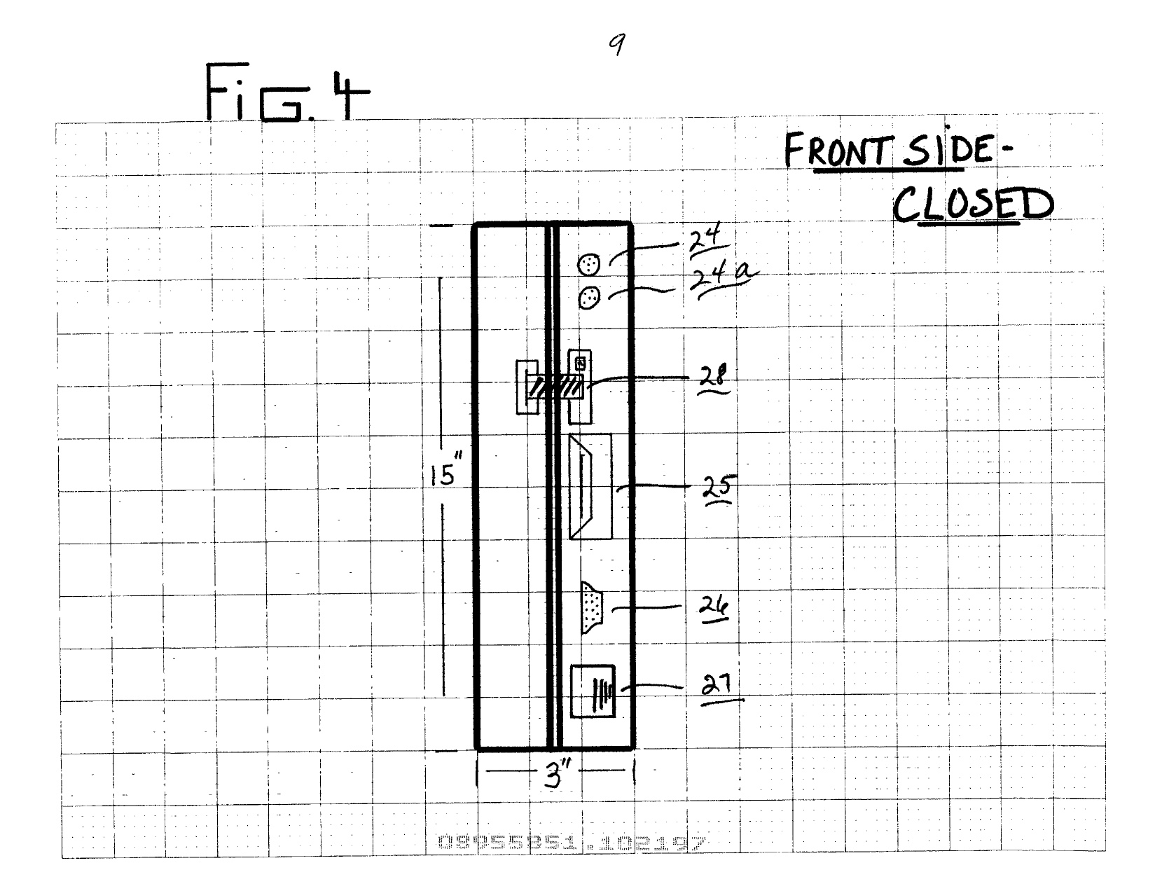

Referring now to FIG. 4, a view of the front side of our invention, the electronic music book closed, numerals 24 and 24a are MIDI ports, IN and OUT. MIDI permits interaction between MusicMaster and other computers. MusicMaster's use is enhanced with the addition of MIDI. Numeral 25 is the disk and or ROM drive port in which floppy discs and or CDS are inserted. MusicMaster stores and accepts data from floppy discs inserted into a disc drive or from CDS inserted into a CD ROM drive. Numeral 26 is a printer cable port, as MusicMaster's contents can be printed. Numeral 27 is the storage area for the A/C power cord on which our electronic music book can operate. Numeral 28 is a locking closure mechanism used when MusicMaster is closed.

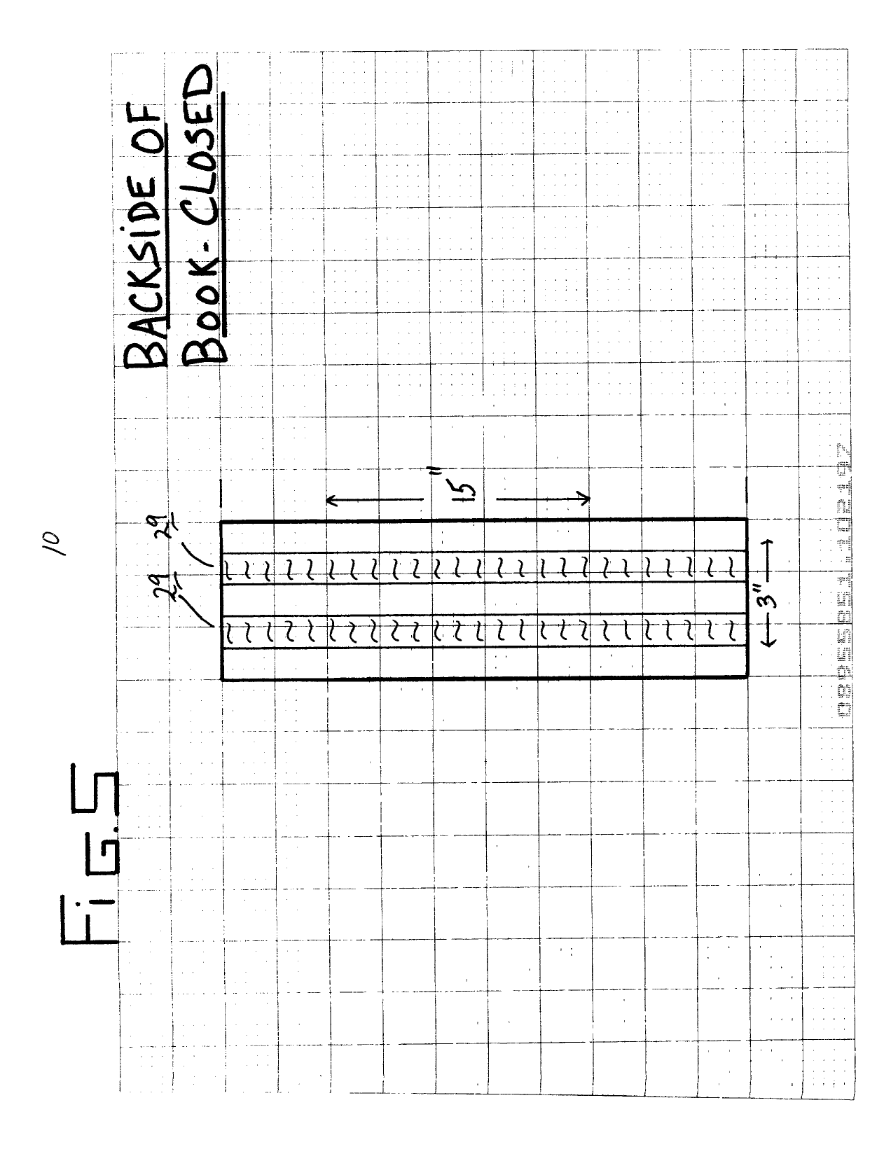

Referring now to FIG. 5, a view of the backside of a closed MusicMaster electronic music book, and specifically numeral 29, are hinges making possible the open and closed design, similiar to ordinary books, of our electronic music book, MusicMaster.

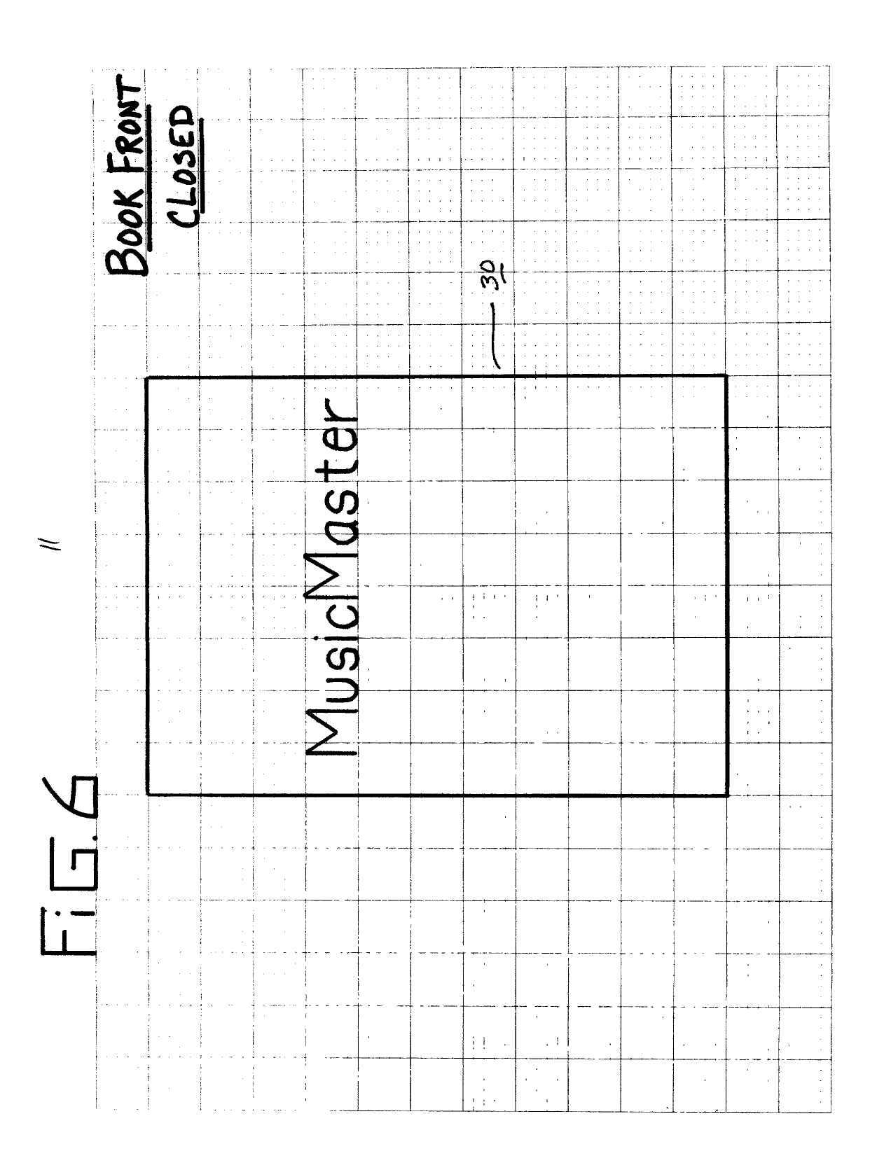

Lastly, FIG. 6, is a perspective view of MusicMaster when closed. It is the book front. Numeral 30 refers to the embodiment of the present invention. The casing of MusicMaster is non-breakable and shock-proof.

### SUMMARY OF THE INVENTION ELECTRONIC MUSIC BOOK—MUSICMASTER

IT IS THEREFORE ONE OF THE PRINCIPAL OBJECTS OF THE PRESENT INVENTION TO PROVIDE AN ELECTRONIC MUSIC BOOK WHICH IS DESIGNED SO ITS USE, NAMELY THE READING OF THE MUSIC WHEN DISPLAYED, IS AS CONGENIAL TO THE USER AS WHEN ONE IS READING MUSIC FROM STANDARD PRINT FORMATS. TO ACCOMPLISH THIS, SAID ELECTRONIC MUSIC BOOK IS DESIGNED WITH TWO DISPLAY SCREENS, IN THE FASHION OF REGULAR MUSIC BOOKS, THAT IS, EACH SCREEN IS APPROXIMATELY NINE INCHES WIDE BY TWELVE INCHES HIGH. WHEN SAID ELECTRONIC MUSIC BOOK IS OPEN, THERE IS A “PAGE”, (SCREEN), ON THE LEFT, AND A “PAGE”, (SCREEN), ON THE RIGHT. FURTHER, THE NOTATION SIZE OF THE MUSIC WHICH IS DISPLAYED, IS THE SIZE OF STANDARD PRINT MUSIC. THE COMBINATION OF DUAL SCREENS, STANDARD MUSIC BOOK SIZE, AND STANDARD NOTATION SIZE MAKE SAID ELECTRONIC MUSIC BOOK USABLE AS A PERFORMANCE TOOL.

MUSICMASTER IS A PIECE OF COMPUTER HARDWARE. IT IS AN ELECTRONIC MUSIC BOOK. IT HAS DUAL SCREENS AND OPENS AND CLOSES LIKE ANY ORDINARY BOOK DOES. IT HAS AN EASY TO USE KEYBOARD FOR TEXT OR DATA ENTRY. IT RUNS ON SELF-CONTAINED BATTERY POWER OR FROM AN EXTERNAL AC OUTLET. THOUGH MUSICMASTER IS ONE BOOK, ITS ABILITY AND PURPOSE IS TO CONTAIN AND DISPLAY WITH EASE, THOUSANDS OF PIECES OF MUSIC. IT IS THEREFORE ANOTHER OBJECT OF THIS INVENTION THAT MUSICMASTER CONSOLIDATES MANY BOOKS AND PAGES OF MUSIC INTO ONE BOOK. IT STORES, CATEGORIES, LISTS, SEARCHES AND SCANS SPECIFIC CATEGORIES, AND DISPLAYS ANY OF ITS CONTENTS. MUSICMASTER ACCEPTS DATA FROM FLOPPY DISCS INSERTED INTO A CD ROM DRIVE. IT CAN BE PROGRAMMED FOR PERSONAL ORGANIZATION OF ITS CONTENTS BY PRESELECTION OF TITLES. MUSICMASTER TURNS PAGES ELECTRONICALLY, AND ALSO PERFORMS OTHER MUSIC DIRECTIVES ELECTRONICALLY, SUCH AS, REPEAT, DAL SEGNO, DA CAPO, AND CODA. ANYTHING THAT IS INSIDE OF MUSICMASTER CAN BE PRINTED THROUGH ITS PARALLEL PRINTER PORT CONNECTED TO AN EXTERNAL PRINTER

BY VIRTUE OF THE INVENTION MUSICMASTER IS THE ANSWER TO THE PROBLEM WHICH EXISTS WITH TRADITIONAL PRINT FORMAT MUSIC. A LARGE QUANTITY OF MUSIC IS VERY HEAVY AND OCCUPIES LOTS OF SPACE. MUSICMASTER IS ONE BOOK, BUT BECAUSE OF ITS ELECTRONIC AND COMPUTER ABILITY, IT IS A COMPILATION OF THOUSANDS OF PIECES OF MUSIC, ENTIRE MUSIC WORKS, MUSIC BOOKS, INSTRUCTION BOOKS, AND ANY OF A VARIETY OF ANTHOLOGIES.

MUSICMASTER MAKES POSSIBLE THE REALITY OF ANYONE POSSESSING AN ENORMOUS VOLUME OF MUSIC OF ANY VARIETY IN A SINGLE, PORTABLE, AND USABLE “BOOK”. MUSICMASTER IS MEANT TO BE USED AS SHEET MUSIC AND MUSIC BOOKS ARE USED. IT CAN BE USED AT A PIANO, AND ON MUSIC STANDS, AND IT IS DURABLE, BUILT TO WITHSTAND THE NORMAL HANDLING ANY MUSIC ENDURES. THE RESOLUTION AND NOTATION SIZE OF THE MUSIC IS SUCH THAT READING FROM MUSICMASTER IS AS CONGENIAL AS THAT OF ORDINARY PRINT MUSIC.

What is claimed is:

1. A TWO-SCREEN ELECTRONIC MUSIC BOOK, WHEREBY MUSIC SCORES ARE RETREIVED FOR DISPLAY AND USE. SAID MUSIC BOOK CAN SELECT FROM THOUSANDS OF A VARIETY OF MUSIC SELECTIONS WHICH ARE ELECTRONICALLY CODED ON A CD ROM, COMPUTER-CARD, DISKS, AND ANY OR OTHER CONTEMPORY MEANS. SAID MUSIC BOOK OPENS ANS CLOSES AS ORDINARY BOOKS DO AND OPENS FLAT. IT CAN BE PLACED ONTO A PIANO, A MUSIC STAND, OR FLAT SURFACE. SAID ELECTRONIC MUSIC BOOK CONTAINS TWO SCREENS WHICH ARE APPROXIMATELY NINE INCHES WIDE BY TWELVE INCHES HIGH

2. A TWO SCREEN ELECTRONIC MUSIC BOOK AS DESCRIBED IN claim 1 WHICH HAS A DATA ENTRY KEYBOARD TO IMPUT INFORMATION FOR THE PURPOSE OF RETREIVING DESIREABLE MUSIC SELECTIONS. A PROGRAMMABLE PRE-SET KEY COMMAND FUNCTION PERMITS PERSONNAL SONG SELECTION ORDER. KEY-TYPE CONTROLS PERFORM OTHER MUSIC DIRECTIVES ELECTRONICALLY, SUCH AS; REPEAT, DA CAPO, DAL SEGNO, CODA, PAGE TURN FORWARD, PAGE TURN BACK. OTHER KEY-TYPE CONTROLS ARE: SCAN, SEEK, COMPOSER ENTER, TITLE ENTER, PAGE NUMBER ENTER, CONTENTS ENTER, PRO-GRAMMABLE PRE-SET ENTER, PRINT, BRIGHTNESS CONTROL, SHARPNESS CONTROL, CONTRAST CONTROL. UNIT ALSO HAS BATTERY INDICATOR LEVEL, AND AN ON AND OFF CONTROL.

3. A TWO SCREEN ELECTRONIC MUSIC BOOK AS DESCRIBED IN claim 2 WHICH HAS THE ABILITY TO BE INTERFACED WITH THE USE OF “MIDI” TO OTHER “MIDI” COMPONENTS BY WAY OF A “MIDI IN” AND A “MIDI OUT” PORT. SAID ELECTRONIC MUSIC BOOK CAN OPERATE ON SELF-CONTAINED BATTERY OR ON A/C POWER.

4. A TWO SCREEN ELECTRONIC MUSIC BOOK AS DESCRIBED IN claim 3 IN WHICH RETREIVED MUSIC SCORES ARE DISPLAYED IN A FASHION THAT RESEMBLES STANDARD PRINT MUSIC, THAT IS, THE SIZE OF THE DISPLAYED NOTATION AND THE SIZE OF THE AREA UPON WHICH THE NOTATION IS DISPLAYED IS EXACTLY THE SIZE OF STANDARD TRADITIONAL PRINT MUSIC, THEREBY ENABLING THE PRACTICAL USE OF SAID ELECTRONIC MUSIC BOOK. PRACTICAL USE REFERS HERE TO THE FEASIBILTY OF READING THE RETREIVED MUSIC FROM THE DISPLAY SCREENS, AND HAVING THE ESSENTIAL ELECTRONIC KEY-FUNCTIONS WHICH NAVIGATE THE USER THROUGH THE PARTICULAR PIECE OF MUSIC THEY ARE READING. THESE ESSENTIAL KEY FUNCTIONS RETURN OR ADVANCE THE USER TO THE CORRECT PAGES OF MUSIC THEY NEED TO BE ON BECAUSE OF THE DIRECTIONS WITHIN THE MUSIC. THESE ARE, CORRESPONDINGLY TO THE KEY-COMMANDS OF SAID ELECTRONIC MUSIC BOOK, “REPEAT”, “PAGE TURN FORWARD”, “PAGE TURN BACK”, “DA CAPO”, “DAL SEGNO”, AND, “CODA”.

5. A TWO SCREEN ELECTRONIC MUSIC BOOK AS DESCRIBED IN claim 4 BUILT TO WITHSTAND THE NORMAL HANDLING ANY MUSIC ENDURES. SAID ELECTRONIC MUSIC BOOK HINGES OPEN AND CLOSED, AND SHUTS SECURELY WITH A CLOSURE MECHANISM.

6. A TWO SCREEN ELECTRONIC MUSIC BOOK AS DESCRIBED IN claim 5 WHEREBY ADDITIONAL FEATURES ARE CONSIDERED AND POSSIBLE. THESE ARE, BUT ARE NOT LIMITED TO: A TRANSPOSITION FUNCTION WHICH WOULD TRANSPOSE SAID BOOK'S CONTENTS. AN AUDIO OUT FUNCTION WHEREBY SAID ELECTRONIC MUSIC BOOK'S CONTENTS CAN BE HEARD.
